(19) United States
(12) Patent Application Publication
(10) Pub. No.: US 2025/0148424 A1
(43) Pub. Date: May 8, 2025

(54) APPOINTMENT ADJUSTMENT SYSTEM, APPOINTMENT ADJUSTMENT METHOD, AND INFORMATION STORAGE MEDIUM

(71) Applicant: Cybozu, Inc., Tokyo (JP)

(72) Inventors: Yoshinori SANO, Tokyo (JP); Narichika ADACHI, Tokyo (JP)

(21) Appl. No.: 18/939,525

(22) Filed: Nov. 7, 2024

(30) Foreign Application Priority Data
Nov. 7, 2023 (JP) 2023-189943

(51) Int. Cl. G06Q 10/1093

(52) U.S. Cl. CPC G06Q 10/1095

(57) ABSTRACT

Provided is an appointment adjustment system including at least one processor, the at least one processor being configured to: acquire communication data indicating content of a communication performed through use of a communication tool; acquire adjustment appointment data indicating an adjustment appointment which is an appointment to be adjusted through the communication based on the communication data and a language-analyzable machine learning model; and transmit the adjustment appointment data to an appointment management tool configured to work in cooperation with the communication tool.

### CROSS-REFERENCE TO RELATED APPLICATION

The present disclosure contains subject matter related to that disclosed in Japanese Patent Application JP 2023-189943 filed in the Japan Patent Office on Nov. 7, 2023, the entire contents of which are hereby incorporated by reference.

### BACKGROUND OF THE INVENTION

### 1. Field of the Invention

The present disclosure relates to an appointment adjustment system, an appointment adjustment method, and an information storage medium.

### 2. Description of the Related Art

Hitherto, there have been known communication tools for users to communicate via email or the like. For example, a user may use a communication tool to adjust an appointment such as a meeting. When the appointment is confirmed, the user registers the appointment in an appointment management tool. When the user is adjusting and registering appointments in this manner, the user is required to go back and forth between the communication tool and the appointment management tool, and hence the operations by the user are complicated.

For example, in “Automatically add events from your email to your calendar,” Internet, retrieved on Oct. 20, 2023, online, (https://support.microsoft.com/en-gb/office/automatically-add-events-from-your-email-to-your-calendar-32e5cf0c-3e65-4870-9ff9-df3683d3fc97), email software, which is an example of a communication tool, is described. The email software of “Automatically add events from your email to your calendar” acquires appointment data indicating an appointment, such as a flight or accommodation, from an email sent by a specific sender such as an airline company or an accommodation facility. The email software of “Automatically add events from your email to your calendar” automatically adds the appointment indicated by the appointment data acquired from the email to an appointment table within the email software.

However, the email software of “Automatically add events from your email to your calendar” can only handle emails that have a specific format and have been sent by a specific sender. The email software of “Automatically add events from your email to your calendar” cannot acquire appointment data from emails from a party with which the user is adjusting an appointment, like emails from airline companies or accommodation facilities, because those emails do not have a fixed format. For this reason, the email software of “Automatically add events from your email to your calendar” lacks versatility and does not sufficiently increase convenience of users.

### SUMMARY OF THE INVENTION

One object of the present disclosure is to increase convenience of a user.

According to at least one aspect of the present disclosure, there is provided an appointment adjustment system including at least one processor, the at least one processor being configured to: acquire communication data indicating content of a communication performed through use of a communication tool; acquire adjustment appointment data indicating an adjustment appointment which is an appointment to be adjusted through the communication based on the communication data and a language-analyzable machine learning model; and transmit the adjustment appointment data to an appointment management tool configured to work in cooperation with the communication tool.

### BRIEF DESCRIPTION OF THE DRAWINGS

FIG. 1 is a diagram for illustrating an example of a hardware configuration of an appointment adjustment system.

FIG. 2 is a view for illustrating an example of a communication screen.

FIG. 3 is a view for illustrating an example of a communication screen.

FIG. 4 is a view for illustrating an example of an appointment management screen.

FIG. 5 is a diagram for illustrating an example of functions implemented by the appointment adjustment system.

FIG. 6 is a table for showing an example of a training database.

FIG. 7 is a table for showing an example of a communication database.

FIG. 8 is a table for showing an example of an appointment management database.

FIG. 9 is a flow chart for illustrating an example of processing to be executed by the appointment adjustment system.

FIG. 10 is a flow chart for illustrating the example of the processing to be executed by the appointment adjustment system.

FIG. 11 is a view for illustrating an example of a communication screen in Modification Example 1.

FIG. 12 is a view for illustrating an example of a communication screen in Modification Example 2.

FIG. 13 is a view for illustrating an example of a communication screen in Modification Example 3.

### DESCRIPTION OF THE EMBODIMENTS

### 1. Hardware Configuration of Appointment Adjustment System

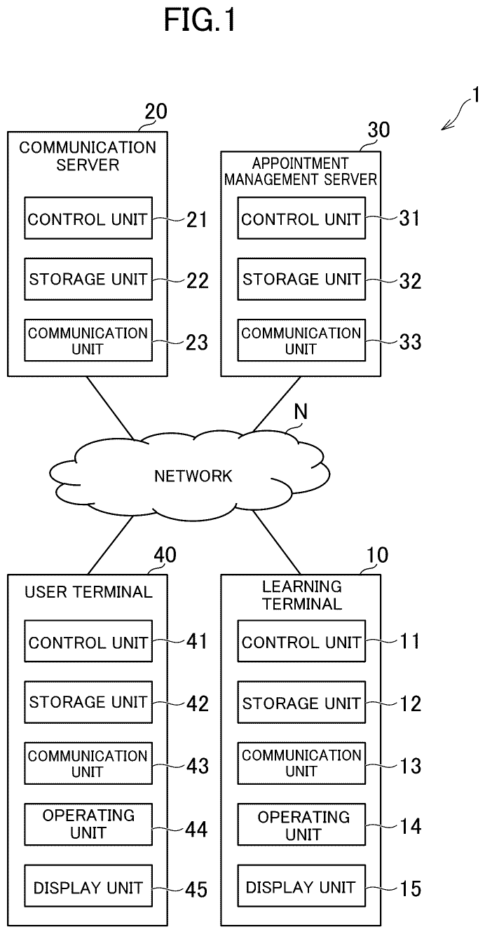

An example of an appointment adjustment system, an appointment adjustment method, and a program according to at least one embodiment of the present disclosure is described. FIG. 1 is a diagram for illustrating an example of a hardware configuration of the appointment adjustment system. For example, an appointment adjustment system 1 includes a learning terminal 10, a communication server 20, an appointment management server 30, and a user terminal 40. The learning terminal 10, the communication server 20, the appointment management server 30, and the user terminal 40 are each connected to a network N, such as the Internet or a LAN.

The learning terminal 10 is a computer which trains a machine learning model described later. For example, the learning terminal 10 is a personal computer, a tablet terminal, or a smartphone. For example, the learning terminal 10 includes a control unit 11, a storage unit 12, a communication unit 13, an operating unit 14, and a display unit 15. The control unit 11 includes at least one processor. The storage unit 12 includes at least one of a volatile memory such as a RAM or a non-volatile memory such as a flash memory. The communication unit 13 includes at least one of a communication interface for wired communication or a communication interface for wireless communication. The operating unit 14 is an input device, such as a mouse or a touch panel. The display unit 15 is a liquid crystal display or an organic EL display.

The communication server 20 is a server computer. For example, the communication server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The appointment management server 30 is a server computer. For example, the appointment management server 30 includes a control unit 31, a storage unit 32, and a communication unit 33. Hardware configurations of the control unit 31, the storage unit 32, and the communication unit 33 may be the same as those of the control unit 11, the storage unit 12, and the communication unit 13, respectively.

The user terminal 40 is a computer of a user. For example, the user terminal 40 is a personal computer, a tablet terminal, or a smartphone. For example, the user terminal 40 includes a control unit 41, a storage unit 42, a communication unit 43, an operating unit 44, and a display unit 45. Hardware configurations of the control unit 41, the storage unit 42, the communication unit 43, the operating unit 44, and the display unit 45 may be the same as those of the control unit 11, the storage unit 12, the communication unit 13, the operating unit 14, and the display unit 15, respectively.

Programs stored in the storage units 12, 22, 32, and 42 may be supplied through the network N. Hardware configurations of the learning terminal 10, the communication server 20, the appointment management server 30, and the user terminal 40 are not limited to the examples of FIG. 1. For example, at least one of the learning terminal 10, the communication server 20, the appointment management server 30, or the user terminal 40 may include at least one of a reading unit (for example, memory card slot) for reading a computer-readable information storage medium or an input/output unit (for example, USB terminal) for directly connecting to an external device. Programs stored in the information storage medium may be supplied through intermediation of at least one of the reading unit or the input/output unit to at least one of the learning terminal 10, the communication server 20, the appointment management server 30, or the user terminal 40.

Further, the appointment adjustment system 1 is only required to include at least one computer. The computers included in the appointment adjustment system 1 are not limited to the example of FIG. 1. For example, the appointment adjustment system 1 may include only the learning terminal 10, the communication server 20, and the appointment management server 30. In this case, the user terminal 40 exists outside the appointment adjustment system 1. The appointment adjustment system 1 may include only the communication server 20. In this case, the learning terminal 10, the appointment management server 30, and the user terminal 40 exist outside the appointment adjustment system 1. The appointment adjustment system 1 may include the communication server 20 and a server computer other than the appointment management server 30.

### 2. Outline of Appointment Adjustment System

In the at least one embodiment, a user adjusts an appointment by using a communication tool. A communication tool is a tool for users to communicate with other people. A communication tool can also be referred to as a program which allows users to transmit messages to other people. The communication tool may be a publicly-known tool. For example, the communication tool may be an email tool, a chat tool, a messaging app, a short message service (SMS), or a social networking service (SNS).

In the at least one embodiment, an email tool is described as an example of a communication tool. For example, users use groupware which includes a communication tool. The groupware is a program that supports users in tasks. The groupware may be any one of a cloud type or an on-premises type. In the at least one embodiment, the communication server 20 manages the communication tool. When the user logs into the groupware and selects the communication tool, the user terminal 40 displays a communication screen, which is a screen of the communication tool, on the display unit 45.

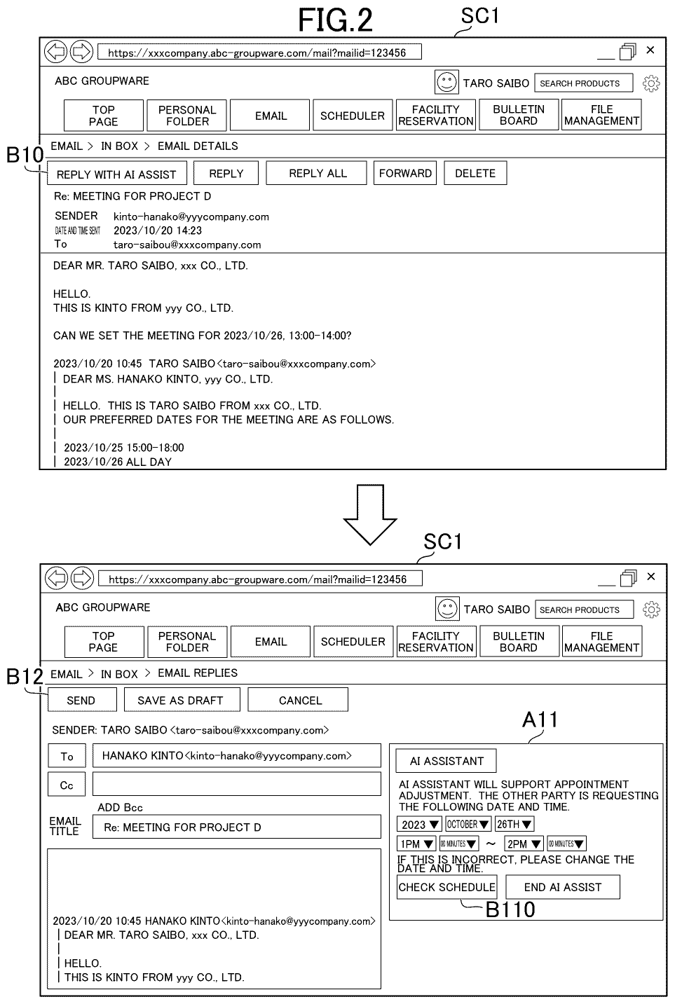

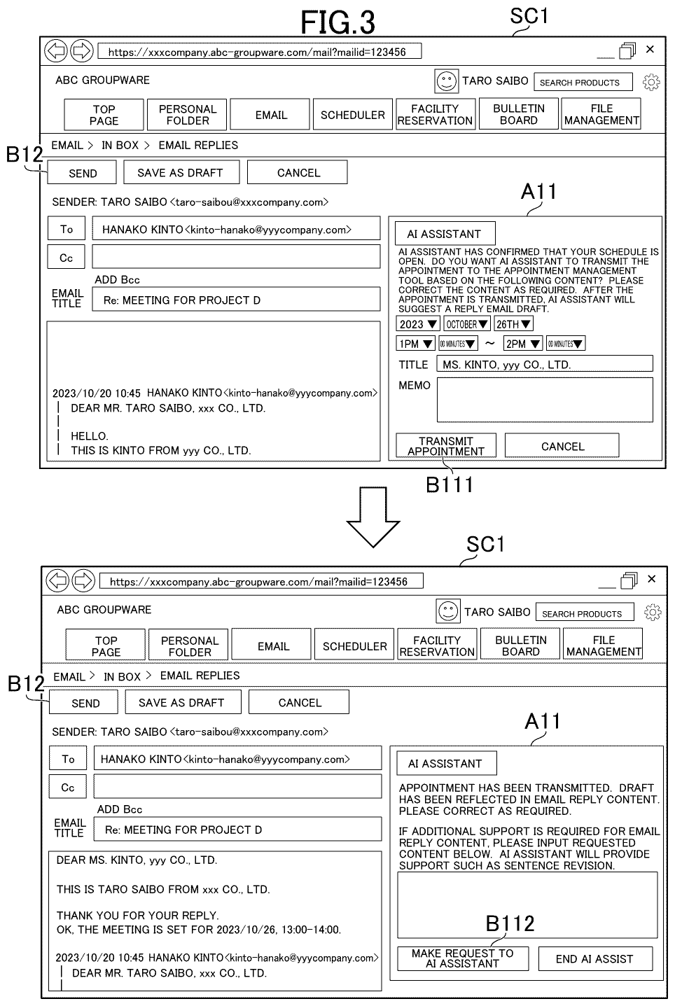

FIG. 2 and FIG. 3 are views for illustrating an example of the communication screen. In the example of FIG. 2 and FIG. 3, a user named “Taro Saibo,” who works at a certain company, uses email to communicate with a person named “Hanako Kinto,” who is outside the company, and adjusts a meeting appointment. The appointment may be anything that is to take place at a predetermined date and time at a predetermined location. The appointment is not limited to a meeting as illustrated in FIG. 2 and FIG. 3. For example, the appointment may be a non-work meeting, an event in which the user is not at the office, a business trip, a seminar, or an interview. The appointment is not limited to something that takes place in real space. The appointment may take place in a virtual space or online. For example, a web conference held at a predetermined URL which corresponds to a location on the Internet may correspond to an appointment.

The appointment which the user adjusts is hereinafter referred to as “adjustment appointment.” The person with whom the user adjusts the appointment (the person that the user is communicating with, in the example of FIG. 2 and FIG. 3, “Hanako Kinto”) is referred to as “adjustment counterpart.” For example, the user sends an email listing a plurality of dates and times as candidates to the email address of the adjustment counterpart. The adjustment counterpart sends an email which includes the date and time that the adjustment counterpart prefers from among those plurality of dates and times to the email address of the user. In the example of a communication screen SC1 in the upper part of FIG. 2, the adjustment counterpart requests the date and time of “Oct. 26, 2023, 13:00-14:00.”

In the at least one embodiment, the communication server supports the adjustment task by the user by identifying the date and time, for example, of the adjustment appointment from the email based on a language-analyzable machine learning model. Details of the machine learning model are described later. For example, when the user selects a button B10 on the communication screen SC1, the communication server 20 uses the machine learning model to identify from in the email the date and time “Oct. 26, 2023, 13:00-14:00” requested by the adjustment counterpart. The email also includes the other dates and times that the user originally provided, but in the at least one embodiment, the machine learning model is trained so as to identify the date and time included in the content of a relatively new reply rather than another date and time included in the content of a relatively old reply.

For example, as illustrated in the lower part of FIG. 2, the communication screen SC1 switches to a reply mode, which is a mode for replying to an email. The communication screen SC1 in the reply mode includes a display area A11 showing the date and time of the adjustment appointment identified by the machine learning model. When the date and time of the adjustment appointment identified by the machine learning model is incorrect, the user can correct the date and time of the adjustment appointment from the display area A11.

For example, when the user selects a button B110 for checking his or her schedule, the communication server 20 checks the schedule of the user based on an appointment management tool in the groupware. The appointment management tool is a tool for managing the appointments of the user. In the at least one embodiment, a case in which the appointment management tool is a tool in the same groupware as the communication tool is described, but the appointment management tool is not required to be a tool in the groupware. In the at least one embodiment, a case in which the appointment management server 30 manages the appointment management tool is given as an example.

An appointment which has been registered in the appointment management tool is hereinafter referred to as “registered appointment.” For example, the communication server 20 checks whether or not the date and time of the adjustment appointment is available based on the date and time of the adjustment appointment and the date and time of the registered appointments. When it is confirmed that the date and time of the adjustment appointment is available, as illustrated in the upper part of FIG. 3, the user terminal 40 displays a message indicating that the date and time of the adjustment appointment is available in the display area A11.

The machine learning model may identify not only the date and time of the adjustment appointment but also at least one of a title or a memo of the adjustment appointment from the email. For example, when the machine learning model has identified at least one of the title or the memo of the adjustment appointment, the user terminal 40 displays the at least one of the title or the memo of the adjustment appointment in the display area A11. In the example of the communication screen SC1 in the upper part of FIG. 3, it is assumed that the machine learning model has identified a title such as “Dear Ms. Kinto, yyy Co., Ltd.” from the recipient name, for example, in the email. The title is displayed in the display area A11. The user can modify the at least one of the title or the memo of the adjustment appointment from the display area A11.

For example, when the user selects a button B111 for transmitting the appointment, the communication server 20 transmits, based on the content displayed in the display area A11, adjustment appointment data indicating the adjustment appointment to the appointment management server 30 managing the appointment management tool. The appointment management server registers the adjustment appointment in the appointment management tool based on the adjustment appointment data. The communication server 20 generates a reply draft based on a template determined in advance. As illustrated in the lower part of FIG. 3, the user terminal 40 displays, on the communication screen SC1, a message indicating that the appointment of the user has been transmitted, and a draft of the reply generated based on the template. When the user selects a button B12 for sending the email, the email is transmitted to the email address of the adjustment counterpart.

The machine learning model may generate the reply draft. For example, the reply draft generated by the machine learning model may be displayed on the communication screen SC1. When the user selects the button B112, the communication server 20 may cause the machine learning model to correct the reply draft. The machine learning model may correct the reply draft in the same way as a publicly-known interactive model.

For example, the user may cause the machine learning model to correct the reply draft by inputting an instruction such as “Please use expressions that are a bit more polite.” The processing by which the machine learning model corrects the draft based on the instruction by the user may be publicly-known processing. When the machine learning model corrects the draft based on the instruction by the user, the user terminal 40 displays the corrected draft on the communication screen SC1. The user may instruct the machine learning model to perform correction again. When the user selects the appointment management tool from the communication screen SC1, the user terminal 40 displays an appointment management screen, which is a screen for the appointment management tool, on the display unit 45.

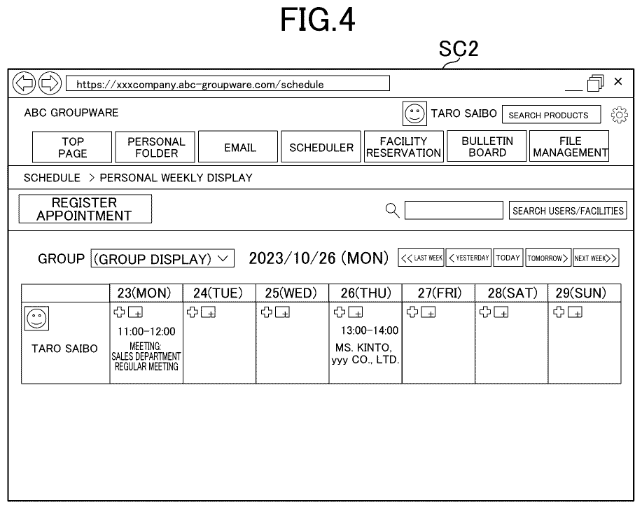

FIG. 4 is a view for illustrating an example of the appointment management screen. In the example illustrated in FIG. 4, the registered appointments registered in the appointment management tool are shown on an appointment management screen SC2. In the example of FIG. 4, the adjustment appointment (appointment at the date and time “Oct. 26, 2023, 13:00-14:00”) that the user has adjusted on the communication screen SC1 in cooperation with the adjustment counterpart is registered in the appointment management tool as a registered appointment. When the user selects a registered appointment displayed on the appointment management screen SC2, the user terminal 40 displays the details of the registered appointment on the appointment management screen SC2.

In this way, the appointment adjustment system 1 uses a machine learning model to identify the date and time, for example, of an adjustment appointment written in an email. The appointment adjustment system 1 allows the user to correct the date and time, for example, as required, and then transmits adjustment appointment data indicating the identified date and time, for example, to the appointment management tool. Through using the machine learning model, the appointment adjustment system 1 can identify the date and time, for example, of an adjustment appointment even when the email is in an undefined format, and thus can increase convenience of the user. Details of the appointment adjustment system 1 are described below.

### 3. Functions Implemented by Appointment Adjustment System

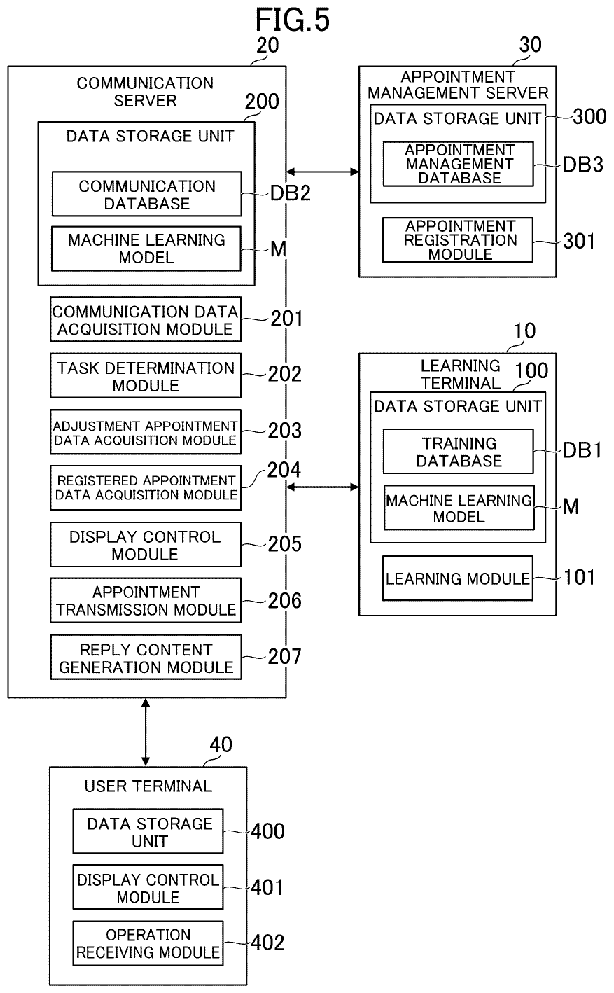

FIG. 5 is a diagram for illustrating an example of functions implemented by the appointment adjustment system 1.

### [3-1. Functions Implemented by Learning Terminal]

For example, the learning terminal 10 includes a data storage unit 100 and a learning module 101. The data storage unit 100 is implemented by the storage unit 12. The learning module 101 is implemented by the control unit 11.

### [Data Storage Unit]

The data storage unit 100 stores data required for the training of a machine learning model M. For example, the data storage unit 100 stores the machine learning model M. The machine learning model M is a model created based on a machine learning method. The machine learning model M may be any type of model used in the field of natural language processing. For example, the machine learning model M may be any of a supervised learning model, a semi-supervised learning model, or an unsupervised learning model.

In the at least one embodiment, a case in which the machine learning model M is a so-called large language model is given as an example. For example, the machine learning model M may be a large language model such as a Generative Pre-trained Transformer (GPT), a Bidirectional Encoder Representation from a Transformer (BERT), a Pathways Language Model (PaLM), or a Large Language Model Meta AI (LLAMA). The machine learning model M may be another model that is not classified as a large language model (for example, a neural network or a sequence-to-sequence model).

For example, the machine learning model M includes parameters that are adjusted through learning. The parameters of the machine learning model M are referred to by the program of the machine learning model M. Examples of the parameters include a weighting factor and a bias. The parameters may be various publicly-known parameters. The parameters are not limited to a weighting factor and a bias. For example, the parameters may be a matrix referred to at the time of calculating an embedded expression, position encoding referred to in the encoding of the token position, or other parameters.

The machine learning model M includes a program for calculating embedded expressions and the like. The program of the machine learning model M includes code indicating internal processing of the machine learning model M. For example, the program of the machine learning model M indicates processing of an encoder which calculates embedded expressions, a decoder which creates data for output corresponding to a task such as appointment adjustment, an output layer which performs final output based on the data, and other intermediate layers. When the machine learning model M is a large language model, the machine learning model M also includes a program which indicates processing of dividing input data into a plurality of tokens. The program of the machine learning model M may be a publicly-known program.

In the at least one embodiment, a case in which a large language model that has been trained in advance corresponds to the machine learning model M is given as an example. For example, the learning module 101 described later retrains the machine learning model M. Retraining is adjusting the parameters of the machine learning model M that has been trained in advance. For example, retraining is fine tuning, transfer learning, or distillation. In place of retraining the machine learning model M, the learning module 101 described later may perform training from scratch on a machine learning model M that has not been trained in advance (a machine learning model M in which the parameters are initial values). The data storage unit 100 stores not only the machine learning model M but also a training database DB1 required for training.

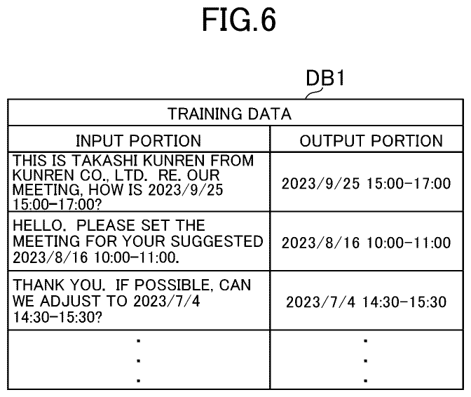

FIG. 6 is a table for showing an example of the training database DB1. The training database DB1 is a database in which training data required for training the machine learning model M is stored. For example, the training data includes an input portion which is input to the machine learning model M during training, and an output portion which is a ground truth during training. The input portion and the output portion may be combined in accordance with the content of the task to be executed by the machine learning model M. The training data may be prepared manually or by using a publicly-known tool.

For example, the input portion of the training data is all or a part of the data indicating a training email. The training email may be an email that has actually been transmitted, or may be an email having virtual content. The training email contains some sort of information relating to a training appointment. For example, the training email may contain the date and time, the title, the memo, the location, the participant(s), or a combination thereof, of the training appointment. The training email may contain other information such as a greeting or small talk unrelated to the appointment.

For example, the output portion of the training data is the portion which is to be identified from the training email. The output portion of the training data indicates a portion of the text of the training email. For example, the output portion of the training data is a portion of the training email which describes the date and time, the title, the memo, the location, the participant(s), or a combination thereof, of the training appointment. The output portion of the training data may be annotated by the creator of the training data, or may be annotated by using a publicly-known tool. In the example of FIG. 6, the output portion of the training data indicates the date and time of the training appointment.

For example, like in the emails illustrated in FIG. 2 and FIG. 3, a plurality of dates and times may be listed in the relatively old reply content, and the date and time requested by the adjustment counterpart may be listed in the relatively new reply content. The training data may be created so that the machine learning model M can handle such emails. For example, the input portion of the training data may be a training email in which a plurality of dates and times are listed in the relatively old reply content, and the date and time requested by the adjustment counterpart is listed in the relatively new reply content. The output portion of the training data may be the date and time included in the relatively new reply content. The machine learning model can learn which date and time listed in the email to identify by using this training data.

The data stored in the data storage unit 100 is not limited to the example described in the at least one embodiment. It suffices that the data storage unit 100 stores the data required for the training of the machine learning model M. For example, the data storage unit 100 stores a learning program indicating a series of processing steps for training the machine learning model M. It is assumed that a calculation formula for a loss function calculated during training is also shown in the learning program.

### [Learning Module]

The learning module 101 trains the machine learning model M based on each of a plurality of pieces of training data stored in the training database DB1. In the at least one embodiment, a case in which the learning module 101 trains the machine learning model M based on a supervised learning algorithm is given as an example. The learning algorithm may be a publicly-known algorithm. For example, the learning module 101 may train the machine learning model M based on a semi-supervised learning algorithm or an unsupervised learning algorithm.

For example, based on a supervised learning algorithm, the learning module 101 trains the machine learning model M by adjusting the parameters of the learning model M so that when the input portion of the training data is input to the machine learning model M, the output portion of the training data is output from the machine learning model M. The learning module 101 calculates, based on a publicly-known loss function, a loss indicating an error between the output from the machine learning model M when the input portion of the training data is input to the machine learning model M and the output portion of the training data. The learning module 101 trains the machine learning model M by adjusting the parameters of the machine learning model M so that the calculated loss becomes smaller. The learning module 101 may repeatedly train the machine learning model M until the loss is less than a threshold value.

For example, the machine learning model M that is being trained divides the text indicated by the input portion of the training data into a plurality of tokens. The machine learning model M encodes each of the plurality of tokens and converts the encoded tokens into a sequence of embedded expressions. The machine learning model M predicts, based on the sequence of embedded expressions, a continuation of the text indicated by the input portion of the training data as required, and calculates an output corresponding to the task. When the difference between the output of the machine learning model M and the output portion of the training data is larger, the loss becomes larger. When the difference between the output of the machine learning model M and the output portion of the training data is smaller, the loss becomes smaller. This series of processing steps is executed based on the program of the machine learning model M (for example, encoder, decoder, output layer, and other layers) and the current parameters of the machine learning model M.

The algorithm used for the training may be a publicly-known algorithm. For example, the learning module 101 trains the machine learning model M based on an error backpropagation method. The learning module 101 may train the machine learning model M based on an algorithm other than the error backpropagation method. For example, the learning module 101 may train the machine learning model M based on a gradient descent method, a momentum method, a quasi-Newton method, a conjugate gradient method, a local search method, or another algorithm.

In the at least one embodiment, the learning module 101 executes a series of processing steps for training by executing the learning program stored in the data storage unit 100. The learning module 101 records the trained machine learning model M in the data storage unit 100. The data storage unit 100 may store both the pre-trained machine learning model M and the trained machine learning model M. The learning module 101 transmits the trained machine learning model M to the communication server 20. The trained machine learning model M transmitted to the communication server 20 is made available for use by the user.

### [3-2. Functions Implemented by Communication Server]

For example, the communication server 20 includes a data storage unit 200, a communication data acquisition module 201, a task determination module 202, an adjustment appointment data acquisition module 203, a registered appointment data acquisition module 204, a display control module 205, an appointment transmission module 206, and a reply content generation module 207. The data storage unit 200 is implemented by the storage unit 22. Each of the communication data acquisition module 201, the task determination module 202, the adjustment appointment data acquisition module 203, the registered appointment data acquisition module 204, the display control module 205, the appointment transmission module 206, and the reply content generation module 207 is implemented by the control unit 21.

### [Data Storage Unit]

The data storage unit 200 stores data required in order to support appointment adjustment. For example, the data storage unit 200 stores a communication database DB2 and the trained machine learning model M.

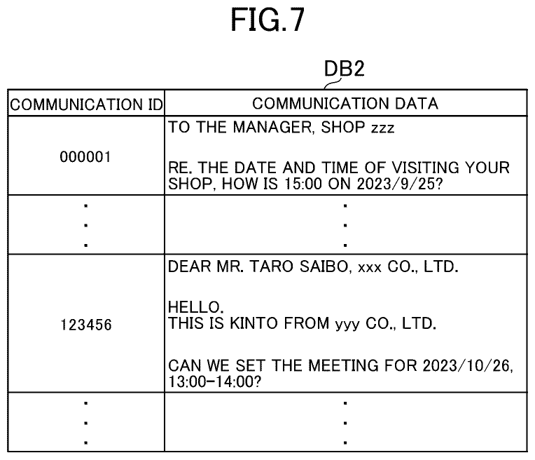

FIG. 7 is a table for showing an example of the communication database DB2. The communication database DB2 is a database in which communication data indicating the content of communication performed through use of the communication tool is stored. For example, the communication database DB2 stores communication IDs and communication data.

The communication ID is an ID for the appointment adjustment system 1 to identify communication data. When a new communication is performed through use of the communication tool, the communication server 20 generates new communication data indicating the new communication. The communication server issues a communication ID for the new communication data. The communication server 20 stores the communication ID and the new communication data in the communication database DB2.

The communication data is text indicating the specific content of the communication. As used herein, “text” does not refer to data having a .txt file extension, but a combination of at least one of letters, numbers, or other symbols. That is, “text” is a sentence having a certain length. It is noted that the communication data may be data having a .txt file extension. The communication data may be in any data format. For example, when the communication data is email data, like in the at least one embodiment, the communication data may be the data of a message file having an .msg file extension, or the data of a character string indicating the body text extracted from the email.

In the at least one embodiment, a case in which the communication data is character string data indicating the body text of an email is given as an example. The communication data may indicate a portion other than the body text of the email (for example, a header). It suffices that the communication data is data that is compatible with the communication tool.

The communication data is not limited to email data. For example, the communication data may be data indicating messages exchanged through a chat tool, a messaging app, an SMS, or an SNS.

The data stored in the data storage unit 200 is not limited to the above-mentioned examples. The data storage unit 200 can store any data. For example, the data storage unit 200 may store a user database in which various types of user data are stored. The user database stores data such as a user ID and a password. The data storage unit 200 may store the data of each screen such as that of the communication screen SC1. The data storage unit 200 may store template data indicating templates of reply content. The data storage unit 200 may store a database similar to an appointment management database DB3 described later.

### [Communication Data Acquisition Module]

The communication data acquisition module 201 acquires communication data. In the at least one embodiment, the communication data is stored in the communication database DB2, and thus the communication data acquisition module 201 acquires the communication data from the communication database DB2. The communication data may be stored in a database other than the communication database DB2. The communication data may be stored on a computer other than the communication server 20. The communication data acquisition e 201 may acquire the communication data from the other database or the other computer.

In the at least one embodiment, the communication data acquisition module 201 acquires, among the emails addressed to the user, the communication data of an email designated by the user. For example, when the user selects the button B10 under a state of the communication screen SC1 in the upper part of FIG. 2, the communication data acquisition module 201 acquires the communication data indicating the email being displayed. The communication data acquisition module 201 may acquire the communication data indicating the email being displayed before the user selects the button B10. It suffices that the communication data acquisition the module 201 acquires communication data indicating an email containing information on the adjustment appointment to be processed.

### [Task Determination Module]

The task determination module 202 determines whether or not the task of the machine learning model M is an appointment adjustment based on the communication data. The task of the machine learning model M is the content of the processing to be executed by the machine learning model M. The machine learning model M may be a model specialized for a specific task, or may be a model not specialized for a specific task. For example, when the machine learning model M is a highly-versatile GPT model, the machine learning model M may not be specialized for a specific task. In this case, in addition to an appointment adjustment task, the machine learning model M can also perform a machine translation task, a summary creation task, a data classification task, or another task. The task that the machine learning model M is to execute may be designated as an input (prompt) to the machine learning model M.

The method of determining the task of the machine learning model M may be a publicly-known method. For example, the task determination module 202 inputs the communication data to the machine learning model M. The machine learning model M divides the text indicated by the communication data into a plurality of tokens. The machine learning model M calculates an embedded expression based on the plurality of tokens and predicts a continuation of the text as required. The machine learning model M analyzes, based on the calculated embedded expression, the context of the text and identifies the task that the machine learning model M is to perform.

For example, when it is determined by the machine learning model M that the text indicated by the communication data includes specific text related to an appointment adjustment (for example, text indicating a given date and time, or text to be used in the appointment adjustment such as “Would the following date and time be convenient for you?”) based on the embedded expression, the machine learning model M determines that the task of the machine learning model M is an appointment adjustment. When it is determined by the machine learning model M that the text indicated by the communication data does not include a specific word related to an appointment adjustment based on the embedded expression, the machine learning model M determines that the task of the machine learning model M is not an appointment adjustment.

The task determination module 202 may determine the task of the machine learning model M without inputting the communication data to the machine learning model M. For example, the task determination module 202 may determine whether or not the task of the machine learning model M is an appointment adjustment by determining whether or not the text indicated by the communication data includes text used in an appointment adjustment, such as “meeting,” based on a dictionary prepared in advance. It is assumed that terms indicating the task of appointment adjustment are registered in the dictionary. The task determination module 202 may determine that the task of the machine learning model M is an appointment adjustment task when a predetermined number or more of terms registered in the dictionary are present in the text indicated by the communication data.

In another example, the task determination module 202 may determine the task of the machine learning model M by using another machine learning model for task determination in addition to the machine learning model M for identifying the date and time of the adjustment appointment and the like. In this case, the another machine learning model has learned relationships between the communication data for training and the tasks of the machine learning model M. The another machine learning model labels whether or not the communication data input to the another machine learning model belongs to the task of appointment adjustment. The task determination module 202 may determine that the task of the machine learning model M is appointment adjustment when the label output by the another machine learning model indicates the appointment adjustment task.

### [Adjustment Appointment Data Acquisition Module]

The adjustment appointment data acquisition module 203 acquires adjustment appointment data indicating an adjustment appointment which is an appointment to be adjusted through communication, based on the communication data and a language-analyzable machine learning model M. The language-analyzable machine learning model M is a machine learning model M which can calculate an embedded expression when some sort of text is input and output a corresponding embedded expression. The machine learning model M used in the field of natural language processing described above corresponds to a language-analyzable machine learning model M.

The adjustment appointment data is data indicating the content of the adjustment appointment. For example, the adjustment appointment data acquisition module 203 acquires adjustment appointment data indicating the date and time of the adjustment appointment. In the at least one embodiment, a situation before the adjustment appointment is finalized is given as an example, and thus the date and time of a candidate adjustment appointment corresponds to the date and time of the adjustment appointment. The adjustment appointment may be finalized via email, and in this case, the adjustment appointment data may indicate the date and time of the finalized adjustment appointment instead of the date and time of the candidate adjustment appointment.

For example, the adjustment appointment data acquisition module 203 may acquire adjustment appointment data indicating the date and time of the adjustment appointment and other information on the adjustment appointment. The other information may be any information other than the date and time. In the at least one embodiment, the other information is at least one of the title of the adjustment appointment or the memo of the adjustment appointment. The other information may include the names of the participant(s) in the adjustment appointment, company information on the participant(s), a location at which the adjustment appointment is to be held, or a facility such as a conference room to be used for the adjustment appointment. In a case of an online conference, the other information may be a URL to be used in the online conference. It is noted that the adjustment appointment data may not indicate the date and time of the adjustment appointment, and only indicate other information about the adjustment appointment. It suffices that the adjustment appointment data indicates, of the text indicated by the communication data, a part of the text related to the adjustment appointment.

For example, the adjustment appointment data acquisition module 203 inputs the communication data to the machine learning model M. The communication data may be input to the machine learning model M by the above-mentioned task determination module 202. The machine learning model M acquires a plurality of tokens and calculates an embedded expression based on the flow described above. The machine learning model M analyzes the context of the text based on the embedded expression, and identifies a portion of the text indicated by the communication data that is related to the adjustment appointment. The machine learning model M outputs adjustment appointment data indicating the identified portion. The adjustment appointment data acquisition module 203 acquires the adjustment appointment data output from the machine learning model M.

In the at least one embodiment, the determination of the task is executed by the task determination module 202, and thus the adjustment appointment data acquisition module 203 acquires adjustment appointment data when it is determined by the task determination module 202 that the task is an appointment adjustment. The adjustment appointment data acquisition module 203 does not acquire adjustment appointment data when it is not determined by the task determination module 202 that the task is an appointment adjustment. When it is not determined by the task determination module 202 that the task is an appointment adjustment, the communication data is not required to be input to the machine learning model M.

In the case of an interactive machine learning model M, the adjustment appointment data acquisition module 203 may input data indicating a task to be executed by the machine learning model M to the machine learning model M together with the communication data. For example, when the user selects the button B10, the adjustment appointment data acquisition module 203 may input data indicating an instruction such as “Please identify and output the date and time, the title, and the memo of the adjustment appointment from this email” to the machine learning model M together with the communication data. The machine learning model M may identify each of the date and time, the title, and the memo of the adjustment appointment from the text indicated by the communication data based on the instruction. The machine learning model M outputs, of the date and time, the title, and the memo of the adjustment appointment, the adjustment appointment data that has been identified.

### [Registered Appointment Data Acquisition Module]

The registered appointment data acquisition module 204 acquires registered appointment data indicating registered appointments that have been registered in the appointment management tool. In the at least one embodiment, the registered appointment data is stored in the appointment management database DB3 stored by the appointment management server 30, and thus the registered appointment data acquisition module 204 acquires the registered appointment data indicating the registered appointment in which the user logged in to the groupware is registered as a participant from the appointment management database DB3 stored by the appointment management server 30.

The registered appointment data may be stored in a database other than the appointment management database DB3. The registered appointment data may be stored on a computer other than the appointment management server 30. The registered appointment data acquisition module 204 may acquire the registered appointment data from the other database or the other computer. For example, the registered appointment data acquisition module 204 acquires registered appointment data indicating the date and time of the registered appointment. The registered appointment data acquisition module 204 may acquire registered appointment data indicating information other than the date and time of the registered appointment.

### [Display Control Module]

The display control module 205 displays various screens on the user terminal 40. For example, the display control module 205 transmits to the user terminal 40 the display data of the screen to be displayed, and displays that screen on the user terminal 40. When the screen is displayed by the browser, the display data of the screen is in the HTML format. The display data on the screen may be in any format. For example, when the screen is displayed by a program dedicated to groupware, the display data of the screen may be in any format supported by the program.

For example, the display control module 205 displays the communication screen SC1 on the user terminal 40 based on the communication data. In the example illustrated in the upper part of FIG. 2, the display control module 205 displays a communication screen SC1 showing the content of an email selected by the user on the user terminal 40 based on the communication data of the email. When the user selects the button B10 and the adjustment appointment data acquisition module 203 acquires the adjustment appointment data, as illustrated in the lower part of FIG. 2, the display control module 205 displays a communication screen SC1 including the content of the communication and the adjustment appointment data indicated by the adjustment appointment data on the user terminal 40.

For example, when the adjustment appointment data indicates the date and time of the adjustment appointment, as illustrated in the lower part of FIG. 2, the display control module 205 displays a communication screen SC1 including the content of the communication and a display area A11 indicating the date and time of the adjustment appointment indicated by the adjustment appointment data on the user terminal 40. In the example illustrated in the lower part of FIG. 2, the content of the communication and the date and time of the adjustment appointment indicated by the adjustment appointment data are displayed on the same communication screen SC1. When the adjustment appointment data indicates information other than the date and time of the adjustment appointment, the display control module 205 displays s a communication screen SC1 that also indicates the other information on the user terminal 40. For example, in the example illustrated in the upper part of FIG. 3, the display control module 205 displays a communication screen SC1 showing the title acquired as other information on the user terminal 40.

For example, the display control module 205 may display a communication screen SC1 showing the content of the communication on the user terminal 40 based on the registered appointment data. For example, the display control module 205 determines whether or not the schedule of the user is open based on the date and time of the adjustment appointment indicated by the adjustment appointment data and the dates and times of the registered appointments indicated by the registered appointment data, and displays the communication screen SC1 on the user terminal 40 based on the result of the determination. In the example illustrated in the upper part of FIG. 3, the display control module 205 displays the result of the determination in the display area A11 based on the registered appointment data and the adjustment appointment data.

For example, the display control module 205 determines whether or not the date and time of the adjustment appointment and the date and time of a registered appointment overlap. When those dates and times do not overlap, the display control module 205 determines that the schedule of the user is open. The method by which the display control module 205 determines whether or not the schedule of the user is open is not limited to the example described above. For example, the display control module 205 may determine whether or not there is a registered appointment within a predetermined time (for example, one hour) before or after the date and time of the adjustment appointment. When it is determined by the display control module 205 that there is no registered appointment within the predetermined time (for example, one hour) before or after the date and time of the adjustment appointment, the display control module 205 determines that the schedule of the user is open.

### [Appointment Transmission Module]

The appointment transmission module 206 transmits the adjustment appointment data to an appointment management tool which works in cooperation with the communication tool. In the at least one embodiment, the appointment transmission module 206 transmitting the appointment adjustment data to the appointment management server 30 corresponds to the appointment transmission module 206 transmitting the adjustment appointment data to the appointment management tool. When the appointment management tool is managed by a computer other than the appointment management server 30, the appointment transmission module 206 may transmit the appointment adjustment data to the another computer.

For example, the appointment transmission module 206 transmits the adjustment appointment data to the appointment management tool based on an operation performed on the communication screen SC1. In the example of FIG. 2 and FIG. 3, selection of the buttons B110 and B111 corresponds to the operation. When the user has selected the button B110 and checked that his or her schedule is open, and has then selected the button B111, the appointment transmission module 206 transmits the adjustment appointment data to the appointment management tool. The operation that the user can perform on the communication screen SC1 may be any operation. The operation by the user is not limited to selecting the buttons B110 and B111. For example, the user may perform an operation on a date-and-time input form displayed in the display area A11, or perform an operation on an input form for at least one of the title or the memo of the adjustment appointment displayed in the display area A11.

In the at least one embodiment, the appointment transmission module 206 transmits the adjustment appointment data acquired by the adjustment appointment data acquisition module 203 to the appointment management tool when the adjustment appointment displayed on the communication screen SC1 is not changed by the user. In the example of FIG. 2 and FIG. 3, when the user does not perform an operation to change the date and time on the date-and-time input form displayed in the display area A11, the appointment transmission module 206 transmits the adjustment appointment data indicating that date and time as it is to the appointment management tool.

For example, when the adjustment appointment displayed on the communication screen SC1 is changed by the user, the appointment transmission module 206 transmits adjustment appointment data indicating the adjustment appointment changed by the user to the appointment management tool. In the example of FIG. 2 and FIG. 3, when the user performs an operation to change the date and time in the date-and-time input form displayed in the display area A11, the appointment transmission module 206 transmits adjustment appointment data indicating the changed date and time to the appointment management tool.

### [Reply Content Generation Module]

The reply content generation module 207 generates reply content data indicating reply content for communication when adjustment appointment data is transmitted to the appointment management tool. For example, the reply content generation module 207 generates reply content data indicating the date and time of an adjustment appointment registered as a registered appointment in the appointment management tool. The reply content generation module 207 may also generate reply content data indicating other content not registered in the appointment management tool.

In the example of the lower part of FIG. 3, the reply content generation module 207 generates reply content data indicating reply content including a greeting registered as a template, the name of the logged-in user, and the name of the organization of the logged-in user. The display control module 205 transmits the reply content data generated by the reply content generation module 207 to the user terminal 40, and the reply content is displayed on the communication screen SC1. Data such as the affiliation and the name of the user in the reply content is stored in advance in the data storage unit 200. The name and the like of the adjustment counterpart in the reply content may be acquired from the email that is the reply source.

The reply content generation module 207 may generate the reply content data based on the machine learning model M. In this case, the machine learning model M can execute the task of generating the reply content. For example, it is assumed that the machine learning model M has learned training data that includes the date and time, for example, of a training appointment and reply content serving as a ground truth. The reply content generation module 207 inputs data such as the date and time of each registered appointment registered in the appointment management tool to the machine learning model M. The machine learning model M calculates an embedded expression of the data based on parameters adjusted by the learning, and outputs reply content data corresponding to the embedded expression. The reply content generation module 207 acquires the reply content data from the machine learning model M.

For example, in the case of an interactive machine learning model M, the reply content generation module 207 may cause the machine learning model M to correct the reply content based on an instruction input by the user. For example, when the user inputs an instruction such as “Please use expressions that are a bit more polite,” the reply content generation module 207 causes the machine learning model M to correct the reply content so that expressions in the generated reply content are more polite. In this case, the display control module 205 transmits the data indicating the corrected reply content to the user terminal 40, and displays the corrected reply content on the communication screen SC1. The user may repeat the correction of the reply content while repeating the interaction with the machine learning model M. The user may by themselves manually correct the reply content generated or corrected by the machine learning model M. The user can input any instructions to the machine learning model M. The instruction input by the user is not limited to the example described above. For example, the user may input an instruction to simplify the reply draft, the language of the reply draft, the number of characters in the reply draft, or another instruction. The machine learning model M may change the reply content based on those instructions.

### [3-3. Functions Implemented by Appointment Management Server]

For example, the appointment management server 30 includes a data storage unit 300 and an appointment registration module 301. The data storage unit 300 is implemented by the storage unit 32. The appointment registration module 301 is implemented by the control unit 31.

### [Data Storage Unit]

The data storage unit 300 stores data required in order to manage the appointments. For example, the data storage unit 300 stores the appointment management database DB3.

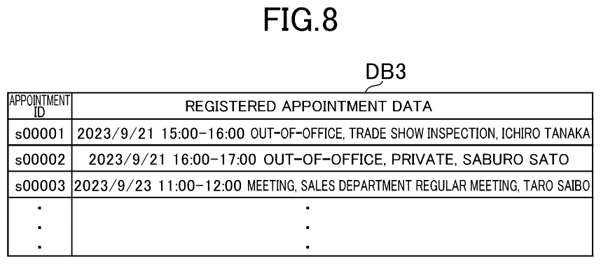

FIG. 8 is a table for showing an example of the appointment management database DB3. The appointment management database DB3 is a database in which registered appointment data indicating the registered appointments registered in the appointment management tool is stored. For example, the appointment management database DB3 stores appointment IDs and registered appointment data. In the at least one embodiment, storing the appointment IDs and the registered appointment data in the appointment management database DB3 corresponds to registering the registered appointments in the appointment management tool.

The appointment ID is an ID for the appointment adjustment system 1 to uniquely identify a registered appointment. When a new registered appointment is registered in the appointment management tool, the communication server 20 generates an appointment ID for the new registered appointment. The communication server 20 generates registered appointment data indicating the new registered appointment. The communication server 20 registers the new registered appointment in the appointment management tool by storing the generated appointment ID and the registered appointment data in the appointment management database DB3. The registered appointment data is data indicating the specific content of the registered appointment. For example, the registered appointment data indicates the date and time, the title, the memo, the participant(s), or a combination thereof, of the registered appointment.

The data stored in the data storage unit 300 is not limited to the example described above. The data storage unit 300 may store any data. For example, the data storage unit 300 may store data for each screen of the appointment management tool.

### [Appointment Registration Module]

The appointment registration module 301 registers the adjustment appointment in the appointment management tool based on the adjustment appointment data transmitted by the appointment transmission module 206. For example, the appointment registration module 301 generates registered appointment data for registering the adjustment appointment as a registered appointment based on the adjustment appointment data. When the user does not change the date and time of the adjustment appointment, the registered appointment data indicates the date and time indicated by the adjustment appointment data. The participant indicated by the registered appointment data is the logged-in user. The user may also designate participants from the communication screen SC1. The appointment registration module 301 issues a new appointment ID, and registers the adjustment appointment in the appointment management tool by storing the appointment ID and the registered appointment data in the appointment management database DB3.

[3-4. Functions implemented by User Terminal]

For example, the user terminal 40 includes a data storage unit 400, a display control module 401, and an operation receiving module 402. The data storage unit 400 is implemented by the storage unit 42. Each of the display control module 401 and the operation receiving module 402 is implemented by the control unit 41.

### [Data Storage Unit]

The data storage unit 400 stores data required in order to perform appointment adjustment. For example, the data storage unit 400 stores a browser for displaying various screens of the appointment adjustment system 1. For example, the data storage unit 400 stores a program dedicated to groupware.

### [Display Control Module]

The display control module 401 displays various screens of the appointment adjustment system 1 on the display unit 45. For example, the display control module 401 displays a screen such as the communication screen SC1 on the display unit 45 based on the display data received from the communication server 20.

### [Operation Receiving Module]

The operation receiving module 402 receives various operations performed in the appointment adjustment system 1. For example, an operation on the communication screen SC1 or the appointment management screen SC2 is received. Data indicating the operation content received by the operation receiving module 402 is transmitted to the communication server 20 as appropriate.

### 4. Processing Executed by Appointment Adjustment System

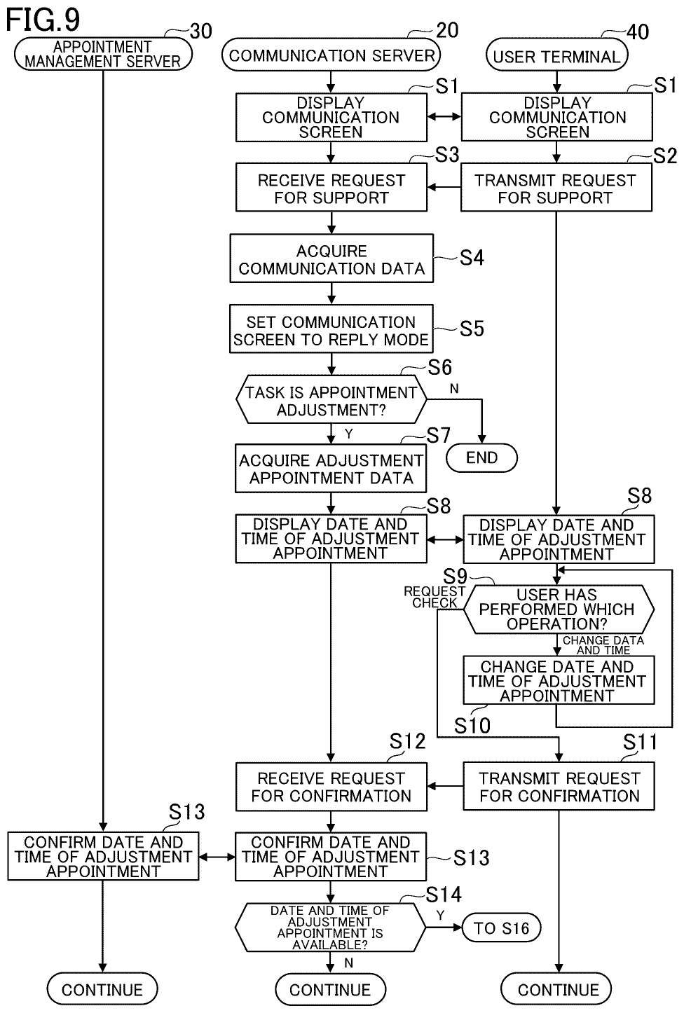

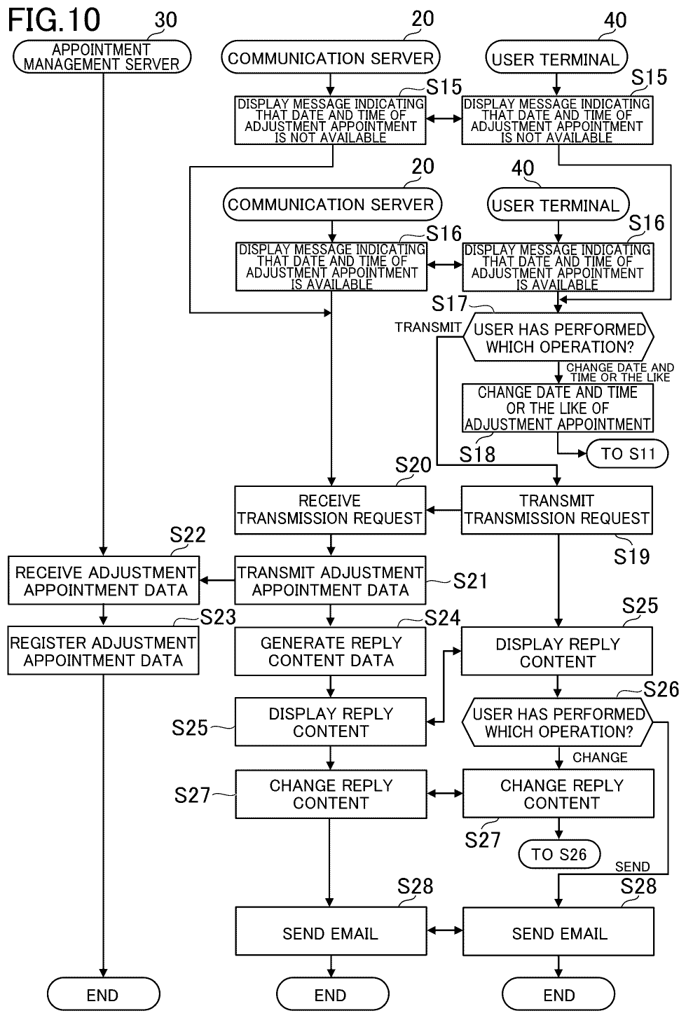

FIG. 9 and FIG. 10 are flow charts for illustrating an example of processing executed by the appointment adjustment system 1. The processing of FIG. 9 and FIG. 10 is executed by the control units 21, 31, and 41 executing the programs stored in the storage units 22, 32, and 42, respectively. It is assumed that the training of the machine learning model M is complete when the processing of FIG. 9 and FIG. 10 is executed. The processing of FIG. 9 and FIG. 10 is an example of the processing included in the appointment adjustment method of the at least one embodiment.

As illustrated in FIG. 9, when the user selects a specific email by using the communication tool, the user terminal 40 executes processing together with the communication server 20 to display the communication screen SC1 showing details of the email selected by the user (Step S1). In Step S1, the communication server 20 generates display data for the communication screen SC1 based on the communication database DB2, and transmits the generated display data to the user terminal 40. The user terminal 40 receives the display data for the communication screen SC1, displays the communication screen SC1 on the display unit 45.

When the user selects the button B10 on the communication screen SC1, the user terminal 40 transmits, to the communication server 20, a support request for the user to request support by the machine learning model M (Step S2). The communication server receives the support request from the user terminal 40 (Step S3). The communication server 20 refers to the communication database DB2, and acquires the communication data of the email to be processed (the email displayed on the communication screen SC1) (Step S4). The communication server 20 executes, together with the user terminal 40, processing for setting the communication screen SC1 to the reply mode as illustrated in the lower part of FIG. 2 based on the communication data (Step S5). The communication server 20 determines whether or not the task of the machine learning model M is an appointment adjustment based on the communication data (Step S6). In Step S6, when it is not determined that the task of the machine learning model M is an appointment adjustment (“N” in Step S6), this series of processing steps ends. In this case, the processing steps after Step S7 are not executed. The communication server 20 may display, on the communication screen SC1, a message indicating that the machine learning model M cannot support the appointment adjustment. In this case, the user manually replies to the email and registers the appointment in the appointment management tool from each of the communication screen SC1 and the appointment management screen SC2.

When it is determined in Step S6 that the task of the machine learning model M is an appointment adjustment (“Y” in Step S6), the communication server 20 acquires the adjustment appointment data indicating the date and time of the adjustment appointment based on the communication data and the machine learning model M (Step S7). In Step S7, the communication server may cause the machine learning model M to identify at least one of the appointment title or the memo. The communication server 20 executes, together with the user terminal 40, processing for displaying the date and time of the adjustment appointment indicated by the adjustment appointment data in the display area A11 (Step S8). When adjustment appointment data is not acquired in Step S7, a message indicating that the adjustment appointment data has not been acquired may be displayed in the display area A11 displayed in Step S8.

The user terminal 40 identifies the operation by the user performed from the operating unit 44 (Step S9). In Step S9, it is assumed that the date and time displayed in the display area A11 is changed or the button B110 is selected. When another operation is performed, processing corresponding to the another operation is executed, and this series of processing steps ends. In Step S9, when the user changes the date and time displayed in the display area A11 (“change date and time” in Step S9), the user terminal 40 changes the date and time of the adjustment appointment (Step S10). In Step S9, when the user selects the button B110 (“request check” in Step S9), the user terminal 40 transmits a request to confirm the appointment to the communication server 20 (Step S11). The confirmation request includes data indicating the date and time displayed in the display area A11.

The communication server 20 receives the appointment confirmation request from the user terminal 40 (Step S12). The communication server 20 executes, together with the appointment management server 30, processing for confirming the date and time of the adjustment appointment (Step S13). In Step S13, the communication server 20 requests the registered appointment data of the user from the appointment management server 30. The appointment management server 30 refers to the appointment management database DB3, acquires the registered appointment data of the user, and transmits the registered appointment data to the communication server 20. The communication server 20 determines whether or not the date and time of the adjustment appointment is available based on the date and time of the adjustment appointment and the dates and times indicated by the registered appointment data of the user.

The communication server 20 determines whether or not the processing result of Step S13 indicates that the date and time of the adjustment appointment is available (Step S14). When it is determined in Step S14 that the date and time of the adjustment appointment is not available (“N” in Step S14), the process proceeds to FIG. 10, and the communication server 20 executes, together with the user terminal 40, processing for displaying, on the communication screen SC1, a message indicating that the date and time of the adjustment appointment is not available (Step S15). In this case, the user changes the date and time of the adjustment appointment as required.

When it is determined in Step S14 that the date and time of the adjustment appointment is available (“Y” in Step S14), the process proceeds to FIG. 10, and the communication server 20 executes, together with the user terminal 40, processing for displaying, on the communication screen SC1, a message indicating that the date and time of the adjustment appointment is available based on the adjustment appointment data (Step S16). When at least one of the appointment title or the memo is identified in Step S7, the at least one of the appointment title or the memo is displayed in the display area A11 based on the processing step of Step S16.

The user terminal 40 identifies the operation by the user performed from the operating unit 44 (Step S17). In Step S17, it is assumed that the date and time or the like displayed in the display area A11 is changed or the button B111 for transmitting the adjustment appointment is selected. When another operation is performed, processing corresponding to the another operation is executed, and this series of processing steps ends. In Step S17, when the user changes the date and time or the like displayed in the display area A11 (“change date and time or the like” in Step S17), the user terminal 40 changes the date and time or the like of the adjustment appointment (Step S18). After that, the process proceeds to Step S11, and the appointment is confirmed.

In Step S17, when the user selects the button B111 for transmitting the adjustment appointment (“transmit” in Step S17), the user terminal 40 transmits, to the communication server 20, a request to transmit the adjustment appointment data (Step S19). The transmission request is data in a predetermined format used by the user terminal 40 to request the communication server to transmit the adjustment appointment data. The communication server 20 receives a transmission request from the user terminal 40 (Step S20). The communication server 20 transmits the adjustment appointment data to the appointment management server 30 (Step S21). In Step S21, when the user does not change the date and time or the like of the adjustment appointment, the communication server 20 transmits the adjustment appointment data acquired in Step S7 as it is. When the user changes the date and time of the adjustment appointment, the communication server 20 transmits the adjustment appointment data indicating the changed date and time or the like.

The appointment management server 30 receives the adjustment appointment data from the communication server 20 (Step S22). The appointment management server 30 registers the adjustment appointment in the appointment management tool based on the adjustment appointment data (Step S23). In Step S23, the appointment management server 30 issues a new appointment ID, and creates a new record in the appointment management database DB3. The appointment management server 30 generates registered appointment data for registering the adjustment appointment as a new registered appointment based on the adjustment appointment data, and stores the generated registered appointment data in the new record.

The communication server 20 generates reply content data based on the adjustment appointment data transmitted to the appointment management tool (Step S24). The communication server 20 executes, together with the user terminal 40, processing for displaying the reply content indicated by the reply content data on the communication screen SC1 (Step S25). The user terminal 40 identifies the operation by the user performed from the operating unit 44 (Step S26). In Step S26, selection of the button B112 for changing the reply content or selection of the button B12 for sending the email is performed. When another operation is performed, processing corresponding to the another operation is executed, and this series of processing steps ends.

In Step S26, when the user selects the button B112 for changing the reply content (“change” in Step S26), the user terminal 40 executes, together with the communication server 20, processing for causing the machine learning model M to change the reply content (Step S27), and the process then returns to Step S26. In Step S26, when the user selects the button B12 for sending the email (“send” in Step S26), the user terminal 40 executes, together with the communication server 20, processing for sending the email (Step S28), and this series of processing steps ends. The transmission of the email can be executed by using publicly-known processing.

### 5. Summary of at Least One Embodiment

The appointment adjustment system 1 of the at least one embodiment acquires adjustment appointment data indicating an adjustment appointment based on communication data and a language-analyzable machine learning model M. The appointment adjustment system 1 transmits adjustment appointment data to an appointment management tool which works in cooperation with a communication tool. As a result, the appointment adjustment system 1 can save the user the time and labor involved in registering the adjustment appointment in the appointment management tool, and thus can increase convenience of the user. For example, an adjustment counterpart does not write emails in a predetermined format, but basically inputs text freely. The appointment adjustment system 1 can acquire the adjustment appointment data by utilizing the language analysis performed by the machine learning model M, even when an email does not have such a predetermined format. Further, the appointment adjustment system 1 can support various types of emails, and thus can implement! highly versatile appointment adjustment support.

Further, the appointment adjustment system 1 registers the adjustment appointment in the appointment management tool based on the adjustment appointment data transmitted by the appointment transmission module 206. As a result, the appointment adjustment system 1 can execute a series of steps from acquiring the adjustment appointment data from an email to registering the adjustment appointment in the appointment management tool.

Further, the appointment adjustment system 1 acquires the adjustment appointment data indicating the date and time of the adjustment appointment and other information on the adjustment appointment. The appointment adjustment system 1 can save the user the time and labor involved in registering not only the time and date of the adjustment appointment but also other information in the appointment management tool, and thus can effectively increase convenience of the user. For example, when the appointment adjustment system 1 registers the title and the memo of the appointment as other information on the adjustment appointment in the appointment management tool, the user is not required to manually input the title and the memo of the appointment, and thus can effectively increase convenience of the user. Even when the title and the memo of the appointment identified by the machine learning model M are partially incorrect, the user is only required to make slight corrections, and thus the appointment adjustment system 1 can improve convenience of the user.

Further, when the adjustment appointment displayed on the communication screen SC1 is not changed by the user, the appointment adjustment system 1 transmits the adjustment appointment data acquired by the adjustment appointment data acquisition module 203 to the appointment management tool. When the adjustment appointment displayed on the communication screen SC1 is changed by the user, the appointment adjustment system 1 transmits the adjustment appointment data indicating the adjustment appointment changed by the user to the appointment management tool. As a result, while checking the email on the communication screen SC1, the user can check the adjustment appointment identified by the machine learning model M and can change the adjustment appointment as required, and thus the appointment adjustment system 1 can effectively improve convenience of the user. For example, the user can register an adjustment appointment in the appointment management tool and also reply to an email without being required to go back and forth between the appointment management tool and the communication tool. For example, the user can take into account content that cannot be read from the text of the email, and make changes such as allocating a longer appointment time.

Further, the appointment adjustment system 1 displays a communication screen SC1 showing the content of the communication on the user terminal 40 based on the registered appointment data. The appointment adjustment system 1 registers an adjustment appointment in the appointment management tool based on an operation performed on the communication screen SC1. As a result, the appointment adjustment system 1 can register the adjustment appointment in the appointment management tool after having the user confirm some information on the registered appointments which are registered in the appointment management tool, and thus it is easier to prevent double bookings, lateness, and the like, and it is possible to effectively improve convenience of the user.

Further, the appointment adjustment system 1 determines whether or not a schedule of the user is open based on the date and time of the adjustment appointment indicated by the adjustment appointment data and the date and time of each registered appointment indicated by the registered appointment data, and displays the communication screen SC1 on the user terminal 40 based on the result of the determination. As a result, the appointment adjustment system 1 can register the adjustment appointment in the appointment management tool after having the user confirm some information on the registered appointments which are registered in the appointment management tool, and thus can more reliably prevent double booking, lateness, and the like.

Further, the appointment adjustment system 1 determines whether the task of the machine learning model M is an appointment adjustment based on the communication data. The appointment adjustment 1 system acquires the adjustment appointment data when it is determined that the task is the appointment adjustment. The appointment adjustment system 1 can prevent non-required processing from being executed for emails unrelated to the appointment adjustment, and hence the processing load on the communication server 20 can be reduced. The appointment adjustment system 1 can also prevent text unrelated to the appointment adjustment from being acquired from an email unrelated to the appointment adjustment, and prevent erroneous appointments from being registered in the appointment management tool.

Further, the appointment adjustment system 1 generates, when the adjustment appointment data is transmitted to the appointment management tool, reply content data indicating the reply content in the communication. As a result, the appointment adjustment system 1 can save the user the time and labor involved in creating a reply to the adjustment counterpart, and thus can effectively improve convenience of the user.

### 6. Modification Examples

The present disclosure is not limited to the at least one embodiment described above, and can be modified suitably without departing from the spirit of the present disclosure.

### 6-1. Modification Example 1

For example, there may be a case in which the machine learning model M identifies a plurality of dates and times of the adjustment appointment from an email. In this case, the display control module 205 may select one of the plurality of dates and times, and display the selected date and time in the display area A11. However, in Modification Example 1, the display control module 205 displays each of the plurality of dates and times in the display area A11. The user may select the date and time to be registered in the appointment management tool from among the plurality of dates and times displayed in the display area A11.

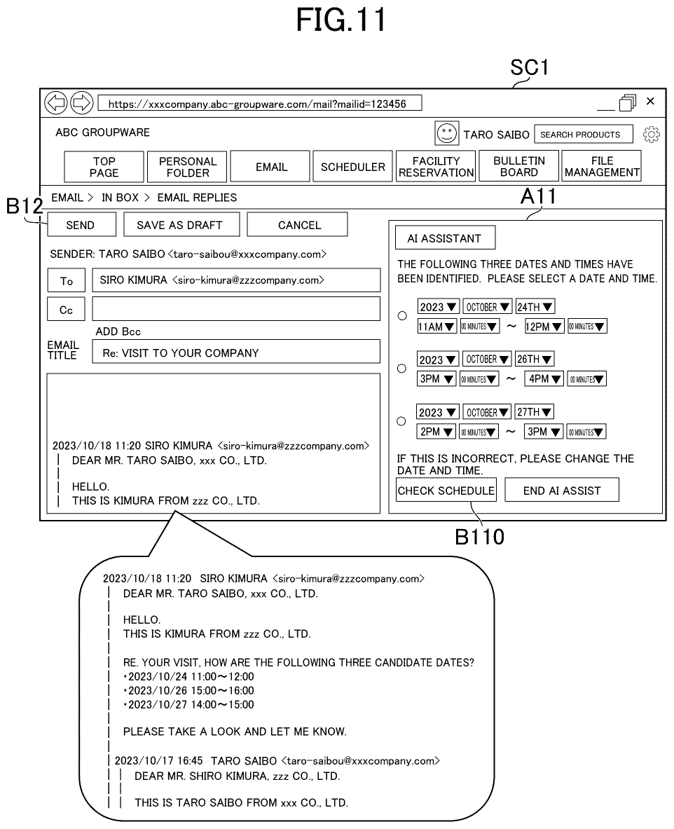

FIG. 11 is a view for illustrating an example of the communication screen SC1 in Modification Example 1. The adjustment appointment data acquisition module 203 in Modification Example 1 acquires adjustment appointment data indicating a plurality of dates and times of an adjustment appointment. For example, the machine learning model M identifies at least one date and time from the text indicated by the communication data based on an embedded expression calculated from the communication data input to the machine learning model M. When the machine learning model M identifies a plurality of dates and times, the machine learning model M outputs adjustment appointment data indicating the plurality of dates and times. The adjustment appointment data acquisition module 203 acquires the adjustment appointment data output from the machine learning model M.

The display control module 205 in Modification Example 1 displays, on the user terminal 40, a communication screen SC1 which includes the content of the communication performed through use of the communication tool and the plurality of dates and times indicated by the adjustment appointment data. For example, the display control module 205 displays, on the user terminal 40, a communication screen SC1 including a display area A11 from which one of the plurality of dates and times can be selected. In the example of the communication screen SC1 of FIG. 11, a case in which the date and time is selected by using a radio button is illustrated, but the display control module 205 may use any method to display the date and time in a selectable manner. For example, the display control module 205 may use a check box, a pull-down menu, or another form to display the date and time in a selectable manner.

The appointment transmission module 206 in Modification Example 1 transmits, to the appointment management tool, appointment adjustment data indicating a date and time selected by the user from among a plurality of dates and times indicated by the adjustment appointment data. For example, in the state of the communication screen SC1 of FIG. 11, when the user selects one of the plurality of dates and times and selects the button B110, the appointment transmission module 206 checks the availability of the selected date and time, and transmits the appointment adjustment data indicating the relevant date and time to the appointment management tool. This is different from the at least one embodiment in that adjustment appointment data indicating the date and time selected by the user from among the plurality of dates and times is transmitted to the appointment management tool, but the processing for transmitting the adjustment appointment data is the same as described in the at least one embodiment.

The appointment adjustment system 1 of Modification Example 1 acquires adjustment indicating a plurality of dates and times of an adjustment appointment. The appointment adjustment system 1 displays a communication screen SC1 that includes the content of the communication performed through use of the communication tool and the plurality of dates and times indicated by the adjustment appointment data. The appointment adjustment system 1 transmits, to the appointment management tool, the appointment adjustment data indicating a date and time selected by the user from among the plurality of dates and times indicated by the adjustment appointment data. The appointment adjustment system 1 effectively increases convenience of the user because the user can select a desired date and time even when the email includes a plurality of dates and times.

### 6-2. Modification Example 2

For example, the communication screen SC1 displayed based on registered appointment data is not limited to the example of the at least one embodiment. In Modification Example 2, another mode of the communication screen SC1 displayed based on registered appointment data is described. The display control module 205 in Modification Example 2 identifies, based on the registered appointment data, a registered appointment of at least one of before or after the date and time of the adjustment appointment indicated by the adjustment appointment data, and displays the communication screen SC1 showing the identified registered appointment on the user terminal 40.

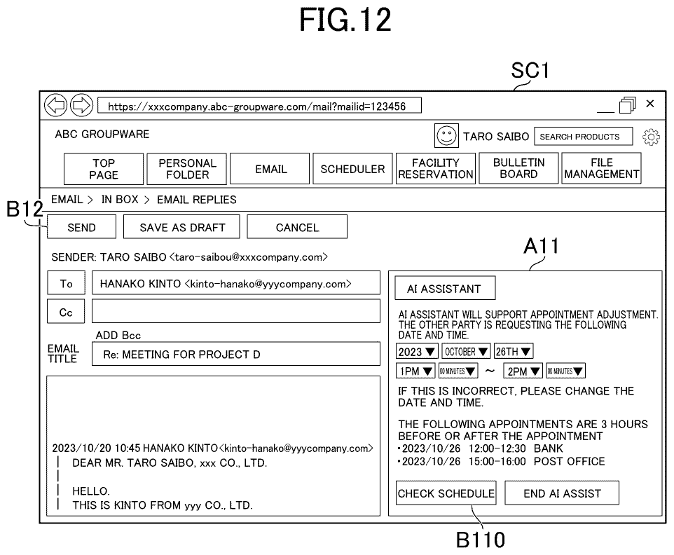

FIG. 12 is a view for illustrating an example of the communication screen SC1 in Modification Example 2. For example, the display control module 205 determines, based on the registered appointment data, whether or not there is a registered appointment within at least one of a predetermined time period (for example, 3 hours) before the date and time of the adjustment appointment or the predetermined time period after the date and time of the adjustment appointment. The display control module 205 displays the relevant registered appointment in the display area A11 when it is determined that there is a registered appointment within the predetermined time period. In Modification Example 2, a case in which the determination is performed in relation to registered appointments both before and after the date and time of the adjustment appointment is given as an example, but the determination may be performed on any one of registered appointments before the date and time of the adjustment appointment or registered appointments after the date and time of the adjustment appointment.

In the example of FIG. 12, the display control module 205 identifies a registered appointment that ends 30 minutes before the start date and time of the adjustment appointment, and a registered appointment that starts one hour after the date and time of the adjustment appointment, and thus displays those two registered appointments in the display area A11. The user checks the display area A11, and changes the date and time of the adjustment appointment as required. The user may change the date and time of the registered appointments without changing the date and time of the adjustment appointment. In addition, the display control module 205 may perform the determination on registered appointments having the same date as the date included in the date and time of the adjustment appointment. The period of time to be determined by the display control module 205 is not limited to the example described in Modification Example 2, and may be any period of time.

The appointment adjustment system 1 of Modification Example 2 identifies, based on the registered appointment data, a registered appointment of at least one of before or after the date and time of the adjustment appointment indicated by the adjustment appointment data, and displays the communication screen SC1 showing the identified registered appointment on the user terminal 40. As a result, the user can register the adjustment appointment in the appointment management tool while checking the registered appointment of at least one of before or after the date and time of the adjustment appointment, and thus the appointment adjustment system 1 can effectively increase convenience of the user. For example, the user can determine the date and time of the adjustment appointment by considering a travel time from the location of a registered appointment before the adjustment appointment, or determine the date and time of the adjustment appointment by considering the travel time from the location of a registered appointment after the adjustment appointment.

### 6-3. Modification Example 3

For example, the display control module 205 may display, on the user terminal 40, a communication screen SC1 which includes travelability information indicating travelability based on the date and time and the location of the adjustment appointment indicated by the adjustment appointment data and the date and time and the location of each registered appointment indicated by the registered appointment data. The travelability information is information indicating whether or not the user can arrive in time at the location of the next registered appointment after the adjustment appointment from the location of the adjustment appointment. The travelability information may indicate whether the user can arrive in time at the location of the adjustment appointment from a registered appointment before the adjustment appointment.

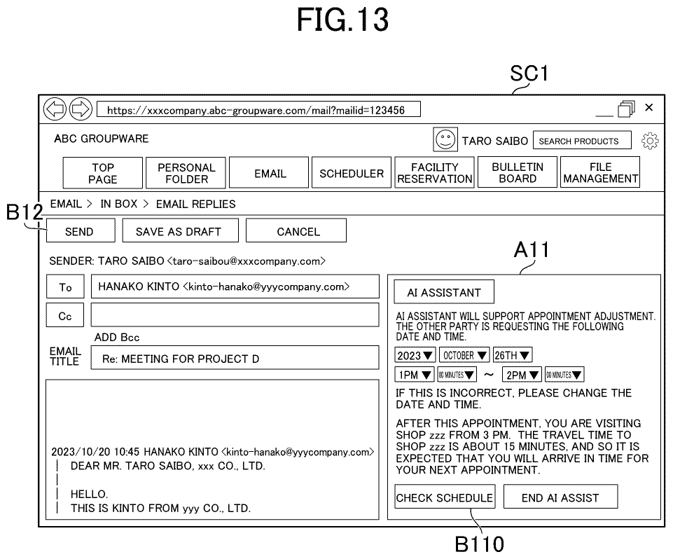

FIG. 13 is a view for illustrating an example of the communication screen SC1 in Modification Example 3. For example, the display control module 205 calculates the travel time between the location of the adjustment appointment and the location of at least one of the previous registered appointment or the next registered appointment. A publicly-known route search algorithm may be used to calculate the travel time. The route search algorithm may calculate the travel time for a case in which the user uses transportation such as a train or a bus. The route search algorithm may be a route search algorithm that is used by a publicly-known map app. The display control module 205 may calculate the travel time by using a publicly-known map app.

For example, each of the location of the adjustment appointment indicated by the adjustment appointment data and the location of the registered appointments indicated by the registered appointment data may indicate an address or a latitude and longitude, or a route search algorithm may indicate information from which the address or the latitude and longitude can be estimated (for example, a company name or a building name). In Modification Example 3, the machine learning model M identifies the location of the adjustment appointment from the body text of the email. The training data for the machine learning model M indicates the training location written in the body text of the training email. The machine learning model M learns the training data. The machine learning model M analyzes the body text of the email indicated by the communication data, identifies the location written in the body text, and outputs adjustment appointment data.

For example, the display control module 205 calculates a time interval between the date and time of the adjustment appointment and the date and time of a registered appointment of at least one of before or after the adjustment appointment. The registered appointment of at least one of before or after the adjustment appointment may be identified in the same way as in Modification Example 2. The time interval may be the interval between the start date and time of the adjustment appointment and the end date and time of a registered appointment before the adjustment appointment, or the interval between the end date and time of the adjustment appointment and the start date and time of a registered appointment after the adjustment appointment. The display control module 205 determines whether or not the calculated travel time is equal or longer than the calculated time interval. The display control module 205 displays travelability information in the display area A11 based on the result of the determination.

For example, the display control module 205 displays, in the display area A11, travelability information indicating that travel is possible when the calculated travel time is less than the calculated time interval. In the example of FIG. 13, the travel time to the next registered appointment after the adjustment appointment is 15 minutes. The time interval between the adjustment appointment and the next registered appointment is one hour. The display control module 205 displays, in the display area A11, travelability information indicating that the travel time of 15 minutes is shorter than the time interval of 1 hour, and hence it is possible to travel to the location of the next registered appointment. Conversely, when the calculated travel time is equal to or longer than the calculated time interval, the display control module 205 displays travelability information indicating that travel is not possible in the display area A11.

The appointment adjustment system 1 of Modification Example 3 displays, on the user terminal 40, a communication screen SC1 which includes travelability information indicating travelability based on the date and time and the location of the adjustment appointment indicated by the adjustment appointment data and the date and time and the location of each registered appointment indicated by the registered appointment data. In the appointment adjustment system 1, the user can grasp whether or not it is possible for the user to travel on the communication screen SC1, and thus convenience of the user can be increased. For example, the appointment adjustment system 1 can prevent a user from being late for an adjustment appointment or from being late for the next registered appointment.

### 6-4. Modification Example 4

For example, an email that has been replied to repeatedly may include a plurality of dates and times that the user has previously presented, or dates and times that were not suitable. The email may also include other dates and times, such as the reply dates and times of other emails. In this case, the machine learning model M may identify the wrong date and time. Thus, the machine learning model M may process only the portion of the email that has a high probability of being the date and time of the adjustment appointment.

The adjustment appointment data acquisition module 203 in Modification Example 4 determines a processing target portion to be processed by the machine learning model M from among the communication data, and acquires the adjustment appointment data based on the machine learning model M and the processing target portion. The processing target portion is a portion of the text indicated by the communication data. For example, the processing target portion is a relatively new portion of the text indicated by the communication data. In the case of an email, the processing target portion is a portion including relatively new reply content written in the email. For other communication tools such as chat, the processing target portion may similarly be a portion including relatively new reply content.

In Modification Example 4, a case in which the most recent reply portion in an email that has been repeatedly replied to corresponds to the processing target portion is given as an example. In the example of the email in the upper part of FIG. 2, the portion before the portion indicating the reply by the user (in FIG. 2, the portion before the line starting with “2023 Oct. 20 10:45”) is the newest reply content, and thus this portion corresponds to the processing target portion. For example, the adjustment appointment data acquisition module 203 identifies the processing target portion based on the position of quotation marks (symbol “|” in FIG. 2) indicating a reply.

The adjustment appointment data acquisition module 203 may identify the portion up to a predetermined number of lines from the top as the processing target portion, instead of the position of quotation marks, or the portion up to the line immediately before a line in which an email address is found in the body text of the email as the processing target portion. The adjustment appointment data acquisition module 203 may identify other portions of the email, excluding portions such as reply date and time, as the processing target portion.

For example, the adjustment appointment data acquisition module 203 inputs the processing target portion of the text indicated by the communication data to the machine learning model M. The machine learning model M divides the processing target portion into a plurality of tokens and calculates an embedded expression. The machine learning model M outputs adjustment appointment data indicating the date and time of the adjustment appointment included in the processing target portion based on the calculated embedded expression. The adjustment appointment data acquisition module 203 acquires the adjustment appointment data output from the machine learning model M. This is different from the at least one embodiment in that the machine learning model M does not process the entire email, but the internal processing of the machine learning model M may be the same as that in the at least one embodiment.

When the machine learning model M is unable to identify the date and time of the adjustment appointment from the processing target portion, the adjustment appointment data acquisition module 203 may input all or a part of the portions of the text indicated by the communication data other than the processing target portion to the machine learning model M. For example, the adjustment appointment data acquisition module 203 may input the portion indicating the most recent reply in an email (in FIG. 2, the reply portion by the user Taro Saibo at “2023 Oct. 20 10:45”) to the machine learning model M. That is, the adjustment appointment data acquisition module 203 may input relatively new processing target portions to the machine learning model M one after another until the machine learning model M identifies some sort of date and time.

The appointment adjustment system 1 of Modification Example 4 determines a processing target portion to be processed by the machine learning model M from among the communication data, and acquires the adjustment appointment data based on the machine learning model M and the processing target portion. The appointment adjustment system 1 can acquire the adjustment appointment data with high accuracy. For example, the appointment adjustment system 1 can prevent incorrect dates and times from being identified from an email that has been repeatedly replied to.

### 6-5. Modification Example 5

For example, in the at least one embodiment, a case in which the adjustment appointment data is acquired from an email managed by groupware is given as an example. In addition to an email, users may also use other communication tools such as a chat or a thread to adjust an appointment. For this reason, the appointment adjustment system 1 may be configured so as to handle each of a plurality of communication tools.

The communication data acquisition module 201 in Modification Example 5 acquires the communication data of each of a plurality of communication tools. The plurality of communication tools may be tools in the same groupware, or may be tools not particularly related to the groupware. In Modification Example 5, a case in which the communication data acquisition module 201 acquires communication data of a first communication tool, which is email, and a second communication tool, which is a chat tool, is given as an example. The communication data acquisition module 201 may acquire communication data from each of three or more communication tools. The communication data of each communication tool may be stored in the data storage unit 200 or may be stored on a computer other than the communication server 20.

The adjustment appointment data acquisition module 203 in Modification Example 5 identifies, from among the plurality of communication tools, the communication tool from which the communication data is acquired, and acquires the adjustment appointment data based on the identified communication tool. For example, when a separate machine learning model M is prepared for each communication tool, the adjustment appointment data acquisition module 203 acquires the adjustment appointment data based on the machine learning model M corresponding to the communication from which the communication data is acquired. It is assumed that each machine learning model M has learned training data created from the communication data of the communication tool corresponding to the machine learning model M. Thus, each machine learning model M has learned a tendency of the communication tool corresponding to the machine learning model M. The internal processing of each machine learning model M may be the same as the internal processing described in the at least one embodiment.

For example, when one machine learning model M can support a plurality of communication tools, the adjustment appointment data acquisition module 203 can input not only the communication data but also data indicating the communication tool from which the communication data is acquired to the learning model M. The input portion of the training data for the machine learning model M also includes data indicating the communication tool. The machine learning model M is trained so as to output the date and time, for example, included in the text indicated by the communication data when communication data for training and data indicating the communication tool corresponding to the communication data are input. The adjustment appointment data acquisition module 203 acquires adjustment appointment data output from the machine learning model M.

The appointment adjustment system 1 of Modification Example 5 identifies, from among a plurality of communication tools, the communication tool from which the communication data is acquired, and acquires the adjustment appointment data based on the identified communication tool. As a result, the appointment adjustment system 1 can support a plurality of communication tools, and hence convenience of the user can be effectively improved. For example, when an email is written in formal text and a chat is written in casual text, the machine learning model M can understand the difference between those texts and identify the adjustment appointment, and thus the machine learning model M can identify the adjustment appointment more accurately.

### 6-6. Other Modification Examples

For example, two or more of Modification Examples 1 to 5 may be combined.

For example, a case in which the appointment adjustment system 1 includes the learning terminal 10 has been given as an example, the appointment adjustment system 1 is not required to include the learning terminal 10, and is not required to train the machine learning model M. In this case, the appointment adjustment system 1 may acquire the adjustment appointment data based on a publicly-known machine learning model M provided free of charge or for a fee. The appointment adjustment system 1 may transmit the adjustment appointment data to the appointment management tool without displaying the adjustment appointment indicated by the adjustment appointment data on the communication screen SC1. The appointment adjustment system 1 may transmit the adjustment appointment data to the appointment management tool without checking whether the user is available.

For example, at least one of the communication tool or the appointment management tool may be a tool unrelated to groupware. In the at least one embodiment and Modification Examples 1 to 5, a case in which the user presents candidate dates and times for the adjustment appointment to the adjustment counterpart is given as an example, but even in a case in which the adjustment counterpart presents the candidate dates and times for the adjustment appointment to the user, the appointment adjustment system 1 may acquire the adjustment appointment data indicating the date and time, for example, of the adjustment appointment based on the same processing as in the at least one embodiment and Modification Examples 1 to 5.

For example, a business entity that: provides a communication tool to users may be different from a business entity that provides an appointment management tool to users. In this case, when it is assumed that those business entities cooperate with each other, the communication server 20 managed by one of the business entities transmits adjustment appointment data to the appointment management server 30 managed by the other of the business entities, and the appointment management server managed by the other of the business entities registers the adjustment appointment in an appointment management tool managed by the other of the business entities based on the adjustment appointment data. In such a case, the series of steps of acquiring the adjustment appointment data, transmitting the adjustment appointment data, and registering the adjustment appointment may be executed by executing the same processing as in the at least one embodiment and Modification Examples 1 to 5. In this case, the appointment adjustment system 1 is not required to include the appointment registration module 301. The appointment registration module 301 may be implemented in a system external to the appointment adjustment system 1.

For example, a given one server computer may manage both the communication tool and the appointment management tool. In this case, the adjustment appointment data is transmitted from the communication tool to the appointment management tool within the server computer. The transmission is performed by inter-process communication, for example. The given server computer transmits the adjustment appointment data from the communication tool stored on the given server computer to the appointment management tool stored on the given server computer through internal communication. The server computer registers the adjustment appointment in the appointment management tool when the adjustment appointment data is transmitted through internal communication.

For example, the functions described as being implemented by the communication server 20 may be implemented by the user terminal 40. In this case, the functions may be implemented by a browser script or an application installed on the user terminal 40. For example, each function may be shared by a plurality of computers or may be implemented by one computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An appointment adjustment system comprising at least one processor, the at least one processor being configured to:
acquire communication data indicating content of a communication performed through use of a communication tool;
acquire adjustment appointment data indicating an adjustment appointment which is an appointment to be adjusted through the communication based on the communication data and a language-analyzable machine learning model; and
transmit the adjustment appointment data to an appointment management tool configured to work in cooperation with the communication tool.

2. The appointment adjustment system according to claim 1, wherein the at least one processor is configured to register the adjustment appointment in the appointment management tool based on the adjustment appointment data.

3. The appointment adjustment system according to claim 1, wherein the at least one processor is configured to acquire the adjustment appointment data indicating a date and time of the adjustment appointment and other information on the adjustment appointment.

4. The appointment adjustment system according to claim 1, wherein the at least one processor is configured to:
display a communication screen including the content of the communication and the adjustment appointment indicated by the adjustment appointment data on a user terminal;
transmit, when the adjustment appointment displayed on the communication screen is not changed by a user, the adjustment appointment data to the appointment management tool; and
transmit, when the adjustment appointment displayed on the communication screen is changed by the user, the adjustment appointment data indicating the adjustment appointment changed by the user to the appointment management tool.

5. The appointment adjustment system according to claim 1, wherein the at least one processor is configured to:
acquire the adjustment appointment data indicating a plurality of dates and times of the adjustment appointment;
display a communication screen including the content of the communication and the plurality of dates and times indicated by the adjustment appointment data on a user terminal; and
transmit, to the appointment management tool, the adjustment appointment data indicating a date and time selected by a user from among the plurality of dates and times indicated by the adjustment appointment data.

6. The appointment adjustment system according to claim 1, wherein the at least one processor is configured to:
acquire registered appointment data indicating a registered appointment which has been registered in the appointment management tool;
display a communication screen showing the content of the communication on a user terminal based on the registered appointment data; and
transmit the adjustment appointment data to the appointment management tool based on an operation performed on the communication screen.

7. The appointment adjustment system according to claim 6, wherein the at least one processor is configured to:
acquire the adjustment appointment data indicating the date and time of the adjustment appointment;
acquire the registered appointment data indicating the date and time of the registered appointment; and
determine whether a schedule of a user is open based on the date and time of the adjustment appointment indicated by the adjustment appointment data and the date and time of the registered appointment indicated by the registered appointment data, and display the communication screen on the user terminal based on a result of the determination.

8. The appointment adjustment system according to claim 6, wherein the at least one processor is configured to:
acquire the adjustment appointment data indicating the date and time of the adjustment appointment;
acquire the registered appointment data indicating the date and time of the registered appointment, and
identify, based on the registered appointment data, a registered appointment of at least one of before or after the date and time of the adjustment appointment indicated by the adjustment appointment data, and display the communication screen showing the identified registered appointment on the user terminal.

9. The appointment adjustment system according to claim 6, wherein the at least one processor is configured to:
acquire the adjustment appointment data indicating the date and time of the adjustment appointment and a location of the adjustment appointment;
acquire the registered appointment data indicating the date and time of the registered appointment and a location of the registered appointment; and
display, on the user terminal, a communication screen which includes travelability information indicating travelability based on the date and time and the location of the adjustment appointment indicated by the adjustment appointment data and the date and time and the location of the registered appointment indicated by the registered appointment data.

10. The appointment adjustment system according to claim 1, wherein the at least one processor is configured to:
determine whether a task of the language-analyzable machine learning model is an appointment adjustment based on the communication data; and
acquire the adjustment appointment data when the task is determined to be the appointment adjustment.

11. The appointment adjustment system according to claim 1, wherein the at least one processor is configured to determine a processing target portion to be processed by the language-analyzable machine learning model from among the communication data, and to acquire the adjustment appointment data based on the language-analyzable machine learning model and the processing target portion.

12. The appointment adjustment system according to claim 1, wherein the at least one processor is configured to generate, when the adjustment appointment data is transmitted to the appointment management tool, reply content data indicating reply content in the communication.

13. The appointment adjustment system according to claim 1, wherein the at least one processor is configured to:
acquire the communication data of each of a plurality of the communication tools; and
identify, from among the plurality of the communication tools, a communication tool from which the communication data is acquired, and acquire the adjustment appointment data based on the identified communication tool.

14. An appointment adjustment method, comprising:
acquiring communication data indicating content of a communication performed through use of a communication tool;
acquiring adjustment appointment data indicating an adjustment appointment which is an appointment to be adjusted through the communication based on the communication data and a language-analyzable machine learning model; and
transmitting the adjustment appointment data to an appointment management tool configured to work in cooperation with the communication tool.

15. A non-transitory information storage medium having stored thereon a program for causing a computer to:
acquire communication data indicating content of a communication performed through use of a communication tool;
acquire adjustment appointment data indicating an adjustment appointment which is an appointment to be adjusted through the communication based on the communication data and a language-analyzable machine learning model; and
transmit the adjustment appointment data to an appointment management tool configured to work in cooperation with the communication tool.
